(19) United States
(12) Patent Application Publication
(10) Pub. No.: US 2019/0331841 A1
(43) Pub. Date: Oct. 31, 2019

(54) ILLUMINATING DEVICE AND DISPLAY DEVICE

(71) Applicant: SHARP KABUSHIKI KAISHA, Sakai City, Osaka (JP)

(72) Inventor: KENJI TAKASE, Sakai City, Osaka (JP)

(73) Assignee: SHARP KABUSHIKI KAISHA, Sakai City ,Osaka (JP)

(21) Appl. No.: 16/473,064

(22) PCT Filed: Dec. 21, 2017
(86) PCT No.: PCT/JP2017/045944

§ 371 Date: Jun. 24, 2019

(30) Foreign Application Priority Data
Dec. 28, 2016 (JP) 2016-256285

(51) Int. Cl. F21V 8/00

(52) U.S. Cl. CPC G02B 6/002; G02B 6/0068; G02B 6/0073; G02B 6/0088; G02B 6/0085; G02B 6/0091

(57) ABSTRACT

An illuminating device that can secure brightness, luminance uniformity, and durability (product life) without increasing a frame width is provided. A light guide plate included in the illuminating device (1) is supported by a support unit (5) that houses light sources (8), incident surfaces (4i and 4i′), and at least a part of a light guide area (4a).

### TECHNICAL FIELD

The disclosure relates to an illuminating device and a display device.

### BACKGROUND ART

In recent years, in a field of an illuminating device and a display device, attempts to differentiate design properties are performed by realizing, for example, enlargement of a light emission area, representation of a floating feeling of an image, and enlargement of a display area by narrowing a frame, so that frame narrowing is considered to be important.

However, when the frame narrowing is performed, a problem of brightness, a problem of luminance uniformity, a problem of durability (product life), and the like of the illuminating device and the display device newly occur, so that the frame narrowing is performed while sacrificing the brightness, the luminance uniformity, and the durability (product life) to some extent in the field of the illuminating device and the display device. Therefore, satisfactory frame narrowing cannot be achieved under the current circumstances.

### CITATION LIST

### Patent Literature

PTL 1: Japanese Unexamined Patent Application Publication No. 2012-74349 (disclosed on Apr. 12, 2012)

### SUMMARY

### Technical Problem

FIG. 12 is a diagram showing a schematic configuration of a conventional display device including a backlight as an illuminating device and a liquid crystal display panel as a display panel.

FIG. 12 (a) is a diagram showing a schematic configuration of a display device 201. The display device 201 includes a liquid crystal display panel 220, a frame (bezel) 203 covering an edge portion of the liquid crystal display panel 220, a support unit 216, and a stand portion 215 for fixing the liquid crystal display panel 220 to the support unit 216.

An edge light type backlight (not shown in the drawings) is arranged on a back surface of the liquid crystal display panel 220. A width of the frame 203 covering a right edge portion, an upper edge portion, and a left edge portion of the liquid crystal display panel 220 is set to be narrow so as to achieve the frame narrowing of the display device 201. A light source of the edge light type backlight is arranged in a lower edge portion of the liquid crystal display panel 220, so that a width of the frame 203 covering the lower edge portion of the liquid crystal display panel 220 is set to be relatively wide.

FIG. 12 (b) is an enlarged diagram of an area F indicated by a dotted line shown in FIG. 12 (a) as seen from above, and is a diagram showing a configuration of the edge light type backlight arranged on the back surface of the liquid crystal display panel 220 shown in FIG. 12 (a). As shown in FIG. 12 (b), the edge light type backlight is a one side light incident type and includes a backlight chassis 213, a light source substrate 207 provided on the backlight chassis 213, light emitting diode elements (LED elements) 208 used as a light source provided on the light source substrate 207, and a light guide plate 204 arranged a predetermined distance away from the light emitting diode elements (LED elements) 208.

As described above, to achieve the frame narrowing, the display device 201 employs an edge light type backlight which is also a one side light incident type backlight where the light emitting diode elements 208 are arranged along the lower edge portion of the liquid crystal display panel 220, so that the number of light emitting diode elements 208 that can be arranged is limited by the length of the one side.

On the other hand, in the case of the liquid crystal display panel 220, high resolution is strongly desired, and the higher the resolution, the lower the transmittance of the liquid crystal display panel 220. Therefore, it is required to increase the luminance of the backlight to be installed. However, as described above, the number of light emitting diode elements 208 that can be arranged is limited. Therefore, in the display device 201, when a high resolution liquid crystal display panel 220 is used, there is a problem that satisfactory brightness cannot be obtained.

In the display device 201, the width of the frame 203 covering the lower edge portion of the liquid crystal display panel 220 is set to be relatively wide. However, the width is minimized in order to achieve the frame narrowing. Therefore, it is difficult to mount a heat dissipation material, whose size is relatively large, close to the light emitting diode element 208. Under these circumstances, when causing the light emitting diode element 208 to emit light by increasing power inputted to the light emitting diode element 208 in order to obtain high luminance, a heating amount of the light emitting diode element 208 increases because no heat dissipation material is provided. Therefore, there is also a problem that a problem of durability (product life) of the display device 201 occurs due to degradation of luminous efficiency of the light emitting diode element 208, degradation of operating life of the light emitting diode element 208, breakdown of peripheral components caused by expansion, and the like.

FIG. 12 (c) is a cross-sectional view of the area F indicated by the dotted line shown in FIG. 12 (a). As shown in FIG. 12 (c), the light source substrate 207 is provided on a side surface of the backlight chassis 213, and the light emitting diode elements 208 are provided on the light source substrate 207. On a main surface of the backlight chassis 213, the light guide plate 204 is arranged a predetermined distance away from the light emitting diode elements 208.

On a back surface of a light emitting area 204b of the light guide plate 204, dots 211 for emitting light from the light emitting diode elements 208 are provided, and a reflection sheet 212 is provided so as to cover the dots 211. On the other hand, on a back surface of a light guide area 204a of the light guide plate 204, only the reflection sheet 212 is provided.

An optical sheet 221 is arranged on a surface of the light guide plate 204, and the liquid crystal display panel 220 is arranged a predetermined distance away from the optical sheet 221 through a plastic chassis 214.

The frame 203 is formed so as to cover the edge portion of the liquid crystal display panel 220, a part of the plastic chassis 214, and side surfaces of the backlight chassis 213.

As shown in FIG. 12 (c), in the display device 201, the width of the frame 203 covering the lower edge portion of the liquid crystal display panel 220 is set to be relatively wide. However, the width is minimized in order to achieve the frame narrowing, so that a distance (light path length) from the light emitting diode elements 208 to the light emitting area 204b of the light guide plate 204 cannot be sufficiently long. Therefore, incident light unevenness occurs due to the light emitting diode elements 208, so there is also a problem that display quality of the display device 201 is degraded.

Here, the above problems are described using a display device as an example. However, these problems also occur in the case of an illuminating device in the same manner. In the case of an illuminating device, the number of light emitting diode elements 208 that can be arranged is limited, so that there occur a problem of not able to increase the luminance of the illuminating device to a predetermined value or more, a problem of durability (product life) of the illuminating device, and a problem that quality degradation of illumination luminance of the illuminating device occurs.

On the other hand, PTL 1 describes a liquid crystal module which improves heat dissipation of light emitting diode elements (LED elements) 208 in an edge light type backlight and suppresses life shortening of the light emitting diode elements due to thermal deterioration, degradation of luminous efficiency, and degradation of luminance.

FIG. 13 (a) is a diagram showing a schematic configuration of a liquid crystal module described in PTL 1, and FIG. 13 (b) is a cross-sectional view of the liquid crystal module described in PTL 1.

As shown in FIG. 13 (a) and FIG. 13 (b), the liquid crystal module described in PTL 1 is a thin type liquid crystal module incorporating an edge type LED backlight, and a transparent light guide plate 302 is housed inside a rear frame 301 made of sheet metal. A pair of left and right belt-plate shaped LED substrates 303a and 303b, on each of which LEDs 330 are aligned in a row and mounted at regular intervals, are installed on a lower surface of the light guide plate 302. The liquid crystal module further includes a liquid crystal panel 304, a light reflecting sheet 305, an optical sheet 306, a cell guide 307, and a bezel 308.

As shown in FIG. 13 (a), a left half of a lower end surface of the light guide plate 302 is an inclined surface 302a that is inclined upward left and a right half of the lower end surface of the light guide plate 302 is an inclined surface 302b that is inclined upward right. The left LED substrate 303a is inclined upward left along the inclined surface 302a of the light guide plate 302 and fixed to a back plate of the rear frame 301, and the right LED substrate 303b is inclined upward right along the inclined surface 302b of the light guide plate 302 and fixed to the back plate 301a of the rear frame 301.

A ventilation space into which air flows is provided between abutting end portions of the LED substrates 303a and 303b, and a ventilation space is also provided between a side plate 301b below the rear frame 301 and the abutting end portions of the LED substrates 303a and 303b.

Ventilation holes 309a and 309b are formed in a central portion of the side plate 301b below the rear frame 301 and central portions of side plates 301c on both left and right sides of the rear frame 301, respectively. Air inside the rear frame 301 warmed by heat from the LEDs 330 is exhausted from the ventilation holes 309b in both left and right side plates 301c. On the other hand, external air flows into inside of the rear frame 301 from the ventilation hole 309a in the lower side plate 301b.

in the liquid crystal module having the configuration as described above, heat dissipation of the LED 330 is improved and temperature rise of the LED 330 is suppressed, so that it is possible to suppress shortening of lifetime and degradation of luminous efficiency and luminance of the LED 330 due to thermal deterioration.

However, in the liquid crystal module described in the PTL 1, an irradiation range of the light guide plate 302 is within a range of a shape of the light guide plate 302. Therefore, when such a light guide plate 302 is used, an entire area of the liquid crystal panel 304 cannot be covered, so that there is a problem that a display range is limited. Thus, satisfactory frame narrowing cannot be achieved.

In the case of the liquid crystal module described in PTL 1, there are problems as described below in addition to the above. When the LED 330, which is a heat generating source, is arranged on a back surface of a display surface of the liquid crystal panel 304, the heat affects operation of the liquid crystal panel 304 and a display unevenness occurs (because generally a liquid crystal operation is accelerated when temperature rises). There are the LED substrates 303a and 303b on a back surface of a display area of the liquid crystal panel 304, so that the liquid crystal panel 304 cannot be applied to a transparent display. Further, there are the ventilation holes 309a and 309b, so that dust is easily accumulated.

The problem that the entire area of the liquid crystal panel 304 cannot be covered and the display range is limited and the problem that dust is easily accumulated because there are the ventilation holes 309a and 309b, which are problems occur when the light guide plate 302 described above is used, are problems which also occur in an illuminating device that does not include the liquid crystal panel 304.

The disclosure has been made in view of the above problems, and an object of the disclosure is to provide an illuminating device that can secure brightness, luminance uniformity, and durability (product life) without increasing a frame width.

### Solution to Problem

To solve the above problems, the illuminating device according to the disclosure is an illuminating device which includes a plurality of light sources and a light guide plate and can be self-stood by a support unit. The light guide plate includes an incident surface through which light from the light sources enters the light guide plate, a light guide area for guiding the light entering from the incident surface to a light emitting area, and the light emitting area from which the light from the light guide area is emitted. The support unit houses the light sources, the incident surface, and at least a part of the light guide area. The light guide plate is supported by the support unit.

According to the configuration described above, the light sources, the incident surface, and at least a part of the light guide area are housed in the support unit, and the light guide plate is supported by the support unit.

Therefore, in the illuminating device described above, the light guide area of the light guide plate is used as a member that connects the light emitting area of the light guide plate with the support unit, and at least a part of the light guide area of the light guide plate is housed in the support unit, so that the length of the light guide area of the light guide plate can be set relatively long and the luminance uniformity of the illuminating device can be secured without increasing the frame width.

Further, the light sources and the incident surface of the light guide plate are housed in the support unit, so that an arrangement form of the light sources can be changed relatively freely. Therefore, the number of the light sources that can be arranged can be increased and the brightness of the illuminating device can be secured without increasing the frame width.

Further, a heat dissipation material can be mounted near the light sources in the support unit, so that it is possible to secure the durability (product life) of the illuminating device without increasing the frame width.

As described above, the illuminating device can secure the brightness, the luminance uniformity, and the durability (product life) without increasing the frame width, and can self-stand because the light guide plate is supported by the support unit.

### Advantageous Effects of Invention

According to an aspect of the disclosure, it is possible to provide an illuminating device that can secure the brightness, the luminance uniformity, and the durability (product life) without increasing the frame width.

### BRIEF DESCRIPTION OF DRAWINGS

FIG. 1 is a diagram showing a schematic configuration of an illuminating device of a first embodiment.

FIG. 2 is a diagram showing a frame width of the illuminating device shown in FIG. 1 and a frame width of a conventional illuminating device.

FIG. 3 is a diagram for explaining a reason why the illuminating device shown in FIG. 1 can secure brightness, luminance uniformity, and durability (product life) without increasing the frame width.

FIG. 4 is a diagram for explaining an effect of suppressing rise of light source temperature and an effect of suppressing degradation of luminous efficiency in the illuminating device shown in FIG. 1.

FIG. 5 is a diagram showing a light guide area of a light guide plate and a support unit used in the illuminating device shown in FIG. 1, and light guide areas of other light guide plates and other support units that can be used in the illuminating device shown in FIG. 1.

FIG. 6 is a diagram showing a schematic configuration of an illuminating device of a second embodiment.

FIG. 7 is a diagram showing a light guide area of a light guide plate and a support unit used in the illuminating device shown in FIG. 6, and light guide areas of other light guide plates and other support units that can be used in the illuminating device shown in FIG. 6.

FIG. 8 is a diagram showing a schematic configuration of an illuminating device of a third embodiment including light source units, in each of which a red light emitting diode element, a green light emitting diode element, and a blue light emitting diode element are arranged adjacent to each other.

FIG. 9 is a diagram showing a spectrum of light from light source units used in the illuminating device shown in FIG. 1 and the illuminating device shown in FIG. 6 and a spectrum of light from the light source units used in the illuminating device shown in FIG. 8.

FIG. 10 is a diagram showing a frame width of a liquid crystal display device of a fourth embodiment and a frame width of a conventional liquid crystal display device.

FIG. 11 is a diagram for explaining a difference of a degree of transparency between the liquid crystal display device of the fourth embodiment and a liquid crystal display device of a fifth embodiment including a transparent liquid crystal display panel.

FIG. 12 is a diagram showing a schematic configuration of a conventional liquid crystal display device having a wide frame width.

FIG. 13 is a diagram showing a schematic configuration of a conventional liquid crystal module disclosed in PTL 1.

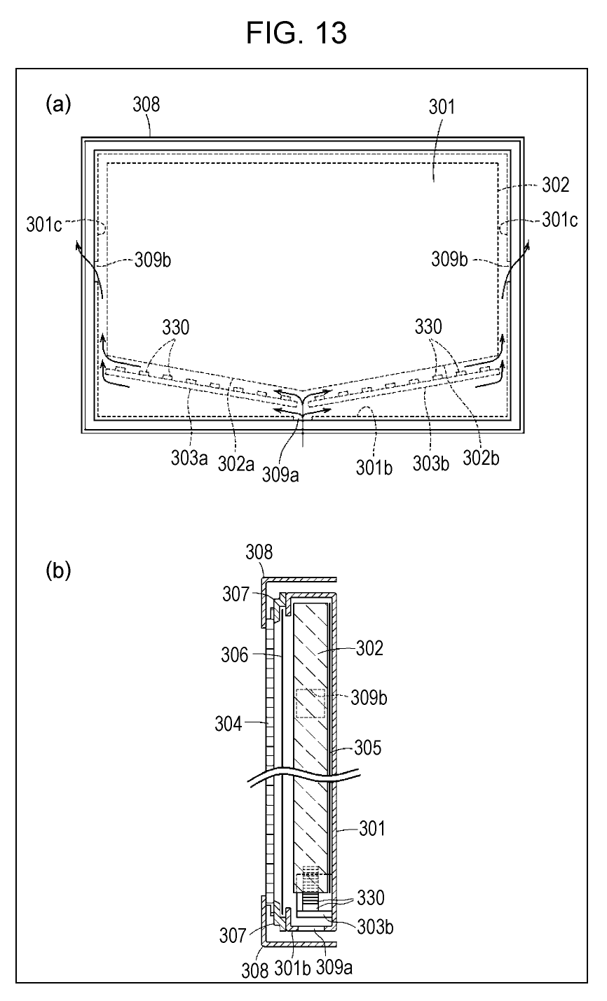

### DESCRIPTION OF EMBODIMENTS

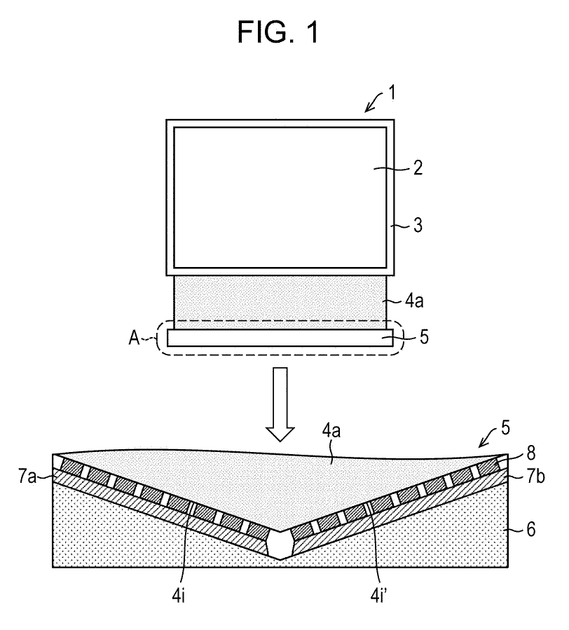

Embodiments of the disclosure will be described with reference to FIGS. 1 to 11. For convenience of description, components having the same function as those described in a certain embodiment are denoted by the same reference numerals, and the description thereof may be omitted.

### First Embodiment

FIG. 1 is a diagram showing a schematic configuration of an illuminating device 1.

As shown in FIG. 1, the illuminating device 1 includes a protective cover 2, a frame (bezel) 3 covering an edge portion of the protective cover 2, a light guide plate including incident surfaces 4i and 4i′ and a light guide area 4a, and a support unit 5.

In FIG. 1, as shown in an enlarged diagram of an area A indicated by a dotted line, the light guide plate includes the incident surfaces 4i and 4i′ through which light from light sources 8 enters the light guide plate, a light guide area 4a for sufficiently diffusing the light entering through the incident surfaces 4i and 4i′ and guiding the light to a light emitting area (not shown in the drawings), and the light emitting area (not shown in the drawings) from which the light from the light guide area 4a is emitted.

The light guide plate including the incident surfaces 4i and 4i′ and the light guide area 4a is supported by the support unit 5 that houses a plurality of light sources 8, the incident surfaces 4i and 4i′, and at least a part of the light guide area 4a, so that the illuminating device 1 has a structure that can self-stand.

A part of the plurality of light sources 8 arranged linearly (a plurality of light sources formed on a light source substrate 7a) are arranged in non-parallel with the other part of the plurality of light sources 8 arranged linearly (a plurality of light sources formed on a light source substrate 7b).

The incident surfaces of the light guide plate include the first incident surface 4i and the second incident surface 4i′. The first incident surface 4i and the second incident surface 4i′ are formed in non-parallel to each other. The plurality of light sources 8 formed on the light source substrate 7a are arranged along the first incident surface 4i and the plurality of light sources 8 formed on the light source substrate 7b are arranged along the second incident surface 4i′.

A heat dissipation material 6 is provided below the light source substrates 7a and 7b in the support unit 5. The heat dissipation material 6 has a shape where the light source substrate 7a can be arranged left-upward and the light source substrate 7b can be arranged right-upward.

The light guide area 4a of the light guide plate and the light emitting area of the light guide plate are integrally formed. The light guide area 4a of the light guide plate and the support unit 5 may be structurally engageably integrated or may be integrated together using an adhesive or the like.

In this way, the light guide area 4a of the light guide plate is used as a member (stand) that connects the light emitting area of the light guide plate with the support unit 5.

In the present embodiment, a case where the protective cover 2 convers only the light emitting area of the light guide plate is described. However, the light guide area 4a of the light guide plate, which is used is as a member (stand) that connects the light emitting area of the light guide plate with the support unit 5, may also be protected by using a protective film or the like.

The heat dissipation material 6 is not particularly limited as long as the heat dissipation material 6 is a material having a high thermal conductivity. However, when considering the weight of the material from a viewpoint of processing easiness and a viewpoint of making the illuminating device 1 self-standable, it is preferable that the heat dissipation material 6 is any one selected from an aluminum material, a copper material, a steel material, and a ceramic material.

In the present embodiment, as the light source 8, a white light emitting diode element (white LED element) including a blue light emitting element and Yttrium Aluminum Garnet (YAG) added with Ce which is a phosphor that emits yellow light (blue-exciting YAG phosphor) is used. However, the light source 8 is not limited to this and, for example, it is possible to use a light source unit where a red light emitting diode element, a green light emitting diode element, and a blue light emitting diode element are arranged adjacent to each other.

In the present embodiment, two light source substrates 7a and 7b which are separated from each other are used. However, a light source is not limited to these light source substrates, but one light source substrate bent at a predetermined angle may be used.

The heat dissipation material 6 and the light source substrates 7a and 7b may be structurally engageably integrated or may be integrated together using an adhesive or the like.

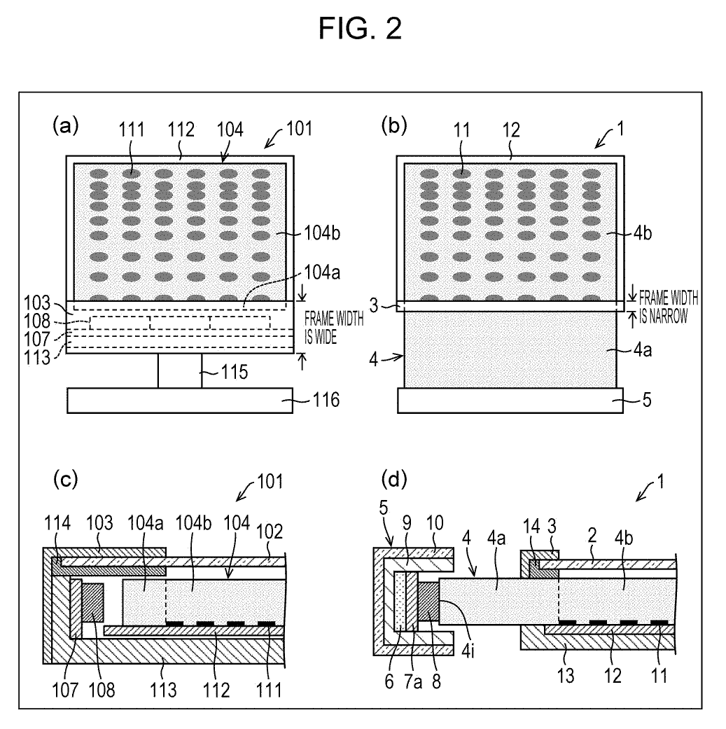

FIG. 2 (a) shows a frame width of a conventional illuminating device 101. FIG. 2 (b) shows a frame width of the illuminating device 1 shown in FIG. 1. FIG. 2 (c) shows a cross-sectional view of the conventional illuminating device 101. FIG. 2 (d) shows a cross-sectional view of the illuminating device 1 shown in FIG. 1.

In the conventional illuminating device 101 shown in FIG. 2 (a) and FIG. 2 (c), a side surface of a backlight chassis 113, a light source substrate 107, light sources 108, and a light guide area 104a of a light guide plate 104 are arranged in a lower portion of a lower frame (bezel) 103, so that a frame width is wide.

Dots 111 are formed on a back surface of a light emitting area 104b of the light guide plate 104. Light that is made incident from the light source 108 into the light guide area 104a of the light guide plate 104 and is guided to the light emitting area 104b of the light guide plate 104 by the light guide area 104a of the light guide plate 104 is emitted from a light emitting surface, which is a surface opposite to the back surface of the light emitting area 104b of the light guide plate 104.

A reflection sheet 112 is provided on the entire back surface of the light guide area 104a and the light emitting area 104b of the light guide plate 104. A protective cover 102 is arranged on a front surface side (including the light emitting surface) of the light guide plate 104 through a plastic chassis 114 a predetermined distance away from the front surface of the light guide plate 104.

The conventional illuminating device 101 includes a stand portion 115 for fixing the backlight chassis 113 to a support unit 116.

Also in the conventional illuminating device 101, in the same manner as the light source 8, the light source 108 uses a white light emitting diode element (white LED element) including a blue light emitting element and Yttrium Aluminum Garnet (YAG) added with Ce which is a phosphor that emits yellow light (blue-exciting YAG phosphor).

On the other hand, in the illuminating device 1 shown in FIG. 2 (b) and FIG. 2 (d), a light guide plate 4 is supported by the support unit 5 that houses the plurality of light sources 8, the incident surfaces 4i and 4i′, and a part of the light guide area 4a, so that the illuminating device 1 has a structure that can self-stand. In other words, the light guide area 4a of the light guide plate 4 is used as a member (stand) that connects a light emitting area 4b of the light guide plate 4 with the support unit 5.

Dots 11 are formed on a back surface of the light emitting area 4b of the light guide plate 4. Light that is made incident from the light source 8 provided in the support unit 5 into the light guide area 4a of the light guide plate 4 through the incident surfaces 4i and 4i′ of the light guide plate 4 and is guided to the light emitting area 4b of the light guide plate 4 by the light guide area 4a of the light guide plate 4 is emitted from a light emitting surface, which is a surface opposite to the back surface of the light emitting area 4b of the light guide plate 4. The dots 11 are not formed in the light guide area 4a of the light guide plate 4, so that the light guide area 4a is transparent (emits no light).

A reflection sheet 12 is provided in a part of the back surface of the light guide plate 4 on a backlight chassis 13, and the protective cover 2 is arranged on a front surface side (including the light emitting surface) of the light guide plate 4 through a plastic chassis 14 a predetermined distance away from the front surface of the light guide plate 4.

The support unit 5 includes a chassis portion 9 having a recessed shape and a housing 10 having a recessed shape. In the chassis portion 9 having a recessed shape, the heat dissipation material 6, the light source substrates 7a and 7b, the plurality of light sources 8, the incident surfaces 4i and 4i′, and a part of the light guide area 4a of the light guide plate 4 are housed.

In the present embodiment, the chassis portion 9 having a recessed shape and the housing 10 having a recessed shape are used. However, the shapes of the chassis portion 9 and the housing 10 are not limited to the shapes mentioned above.

Because of the configuration as described above, in the case of the illuminating device 1, a frame width of a lower frame (bezel) 3 need not be set wide, so that all of the upper, lower, left, and right sides of the frame (bezel) 3 can be narrowed. Therefore, it is possible to improve the design property of the illuminating device 1.

Further, the light guide area 4a of the light guide plate 4 is used as a member (stand) that connects the light emitting area 4b of the light guide plate 4 with the support unit 5, so that the light guide area 4a of the light guide plate 4 can be elongated, and luminance uniformity of light incident from the light sources 8 can be sufficiently improved.

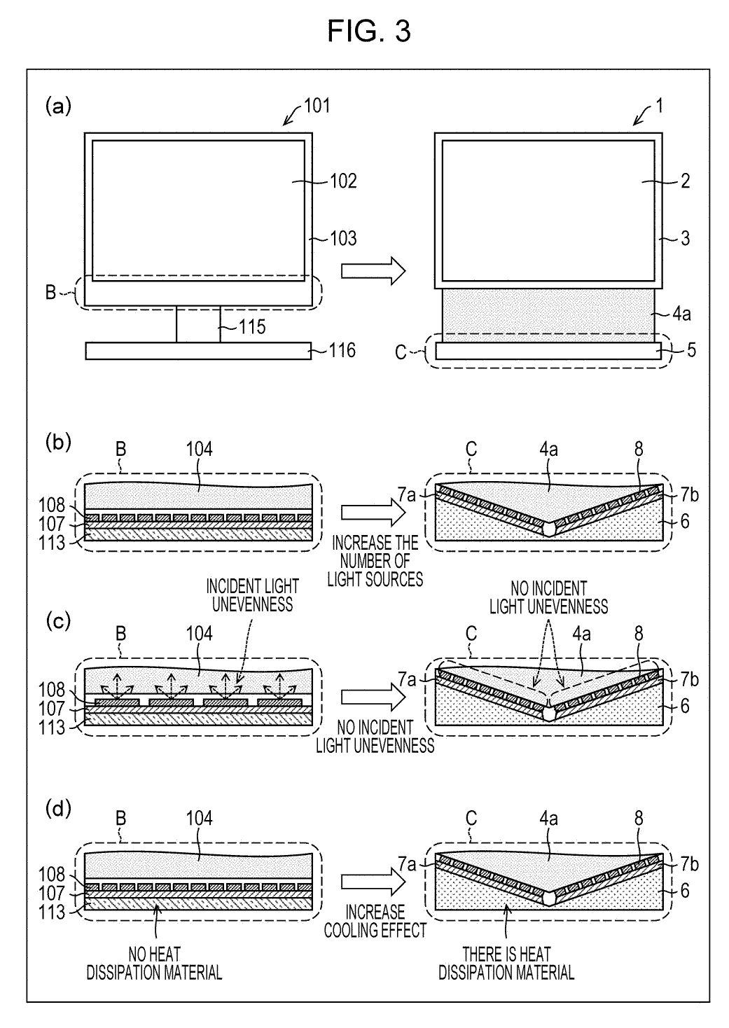

FIG. 3 is a diagram for explaining a reason why the illuminating device 1 can secure brightness, luminance uniformity, and durability (product life) without increasing the frame width as compared with the conventional illuminating device 101.

FIG. 3 (a) is a diagram showing schematic configurations of the conventional illuminating device 101 and the illuminating device 1. FIG. 3 (b), FIG. 3 (c), and FIG. 3 (d) are enlarged diagrams of an area B indicated by a dotted line in the conventional illuminating device 101 shown in FIG. 3 (a) and enlarged diagrams of an area C indicated by a dotted line in the illuminating device 1 shown in FIG. 3 (a).

As shown in FIG. 3 (b), in the case of the conventional illuminating device 101, the frame width is determined by the width of the lower frame (bezel) 103, so that to achieve the frame narrowing, there is no way but to linearly arrange the light sources 108. In this case, the number of light sources 108 that can be arranged is limited. Therefore, it is difficult to increase the brightness of the illuminating device 101 without increasing the frame width.

On the other hand, in the case of the illuminating device 1, the light sources 8 are housed in the support unit 5, so that the arrangement of the light sources 8 does not affect the frame width. Therefore, in the illuminating device 1, a plurality of light sources 8 that are linearly formed on the light source substrate 7a and a plurality of light sources 8 that are linearly formed on the light source substrate 7b are arranged in non-parallel to each other, so that the number of light sources 8 that can be arranged is increased. Therefore, it is possible to increase the brightness of the illuminating device 1 without increasing the frame width.

As shown in FIG. 3 (c), in the case of the conventional illuminating device 101, the frame width is determined by the width of the lower frame (bezel) 103, so that to achieve the frame narrowing, the light guide area 104a of the light guide plate 104 cannot be elongated. As a result, the light from the light sources 108 is emitted from the light emitting surface of the light emitting area 104b of the light guide plate 104 in a state where incident light unevenness remains.

On the other hand, in the case of the illuminating device 1, the light guide area 4a of the light guide plate 4 is used as a member (stand) that connects the light emitting area 4b of the light guide plate 4 with the support unit 5. Therefore, the light guide area 4a of the light guide plate 4 can be elongated, and light is emitted from the light emitting surface of the light emitting area 4b of the light guide plate 4 after the incident light unevenness of the light from the light sources 8 is eliminated in the long light guide area 4a of the light guide plate 4. Thus, the luminance uniformity of the illuminating device 1 can be improved without increasing the frame width.

As shown in FIG. 3 (d), in the case of the conventional illuminating device 101, the frame width is determined by the width of the lower frame (bezel) 103, so that it is difficult to mount a heat dissipation material, whose size is relatively large, close to the light sources 108. Therefore, it is difficult to improve the durability (product life) of the illuminating device 101 without increasing the frame width.

On the other hand, in the case of the illuminating device 1, the light sources 8 are housed in the support unit 5, so that a heat dissipation material 6, whose size is relatively large, may be provided in the support unit 5. Therefore, it is possible to improve the durability (product life) of the illuminating device 1 without increasing the frame width.

In the case of the illuminating device 1, the heat dissipation material 6 is arranged so as to be in contact with the chassis portion 9 and the housing 10, which are a ground contact surface, in the support unit 5. Therefore, heat exhaust of the light sources 8 is realized by a heat dissipation mechanism including the heat dissipation material 6 in the support unit 5, so that a cooling effect is obtained and it is possible to dissipate heat by diffusing heat to the ground contact surface through the heat dissipation material 6. Thus, it is possible to suppress degradation of luminous efficiency of the light sources 8 due to heat generation. This cooling effect is greater than that of air convection of chimney effect.

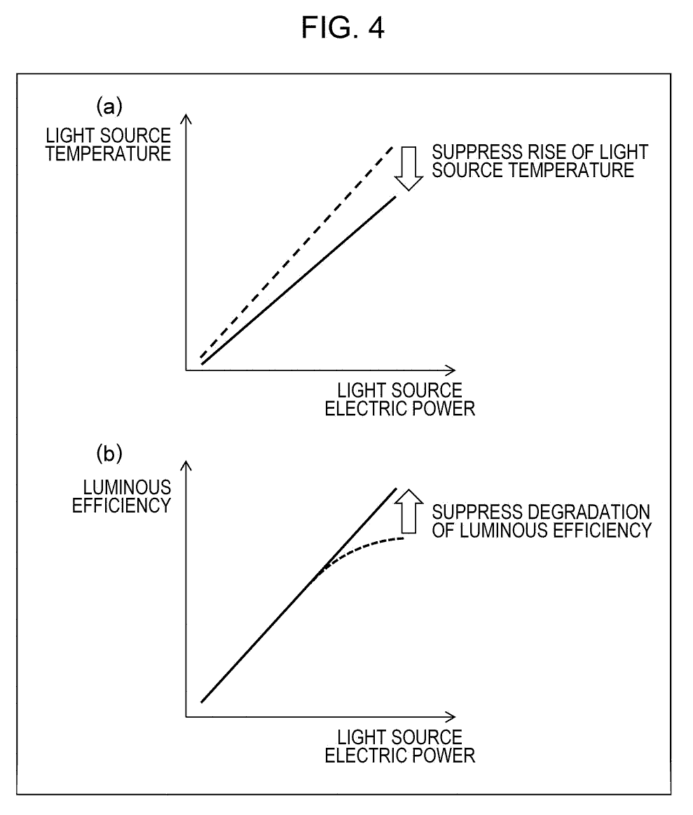

FIG. 4 (a) is a diagram showing an effect of suppressing rise of light source temperature in the illuminating device 1 shown in FIG. 1. FIG. 4 (b) is a diagram showing an effect of suppressing degradation of luminous efficiency in the illuminating device 1 shown in FIG. 1.

The illuminating device 1 includes the heat dissipation material 6 in the support unit 5. Therefore, as shown in FIG. 4 (a), as compared with the conventional illuminating device 101 (indicated by dotted line) that does not include the heat dissipation material 6, the illuminating device 1 (indicated by solid line) that includes the heat dissipation material 6 in the support unit 5 can obtain an effect of further more suppressing the rise of light source temperature with respect to light source power.

When the light source temperature becomes higher than a predetermined value, the luminous efficiency of the light source degrades. Therefore, as shown in FIG. 4 (b), as compared with the conventional illuminating device 101 (indicated by dotted line) that does not include the heat dissipation material 6, the illuminating device 1 (indicated by solid line) that includes the heat dissipation material 6 in the support unit 5 can obtain an effect of further more suppressing the degradation of luminous efficiency because the illuminating device 1 has a high effect of suppressing the rise of light source temperature with respect to light source power.

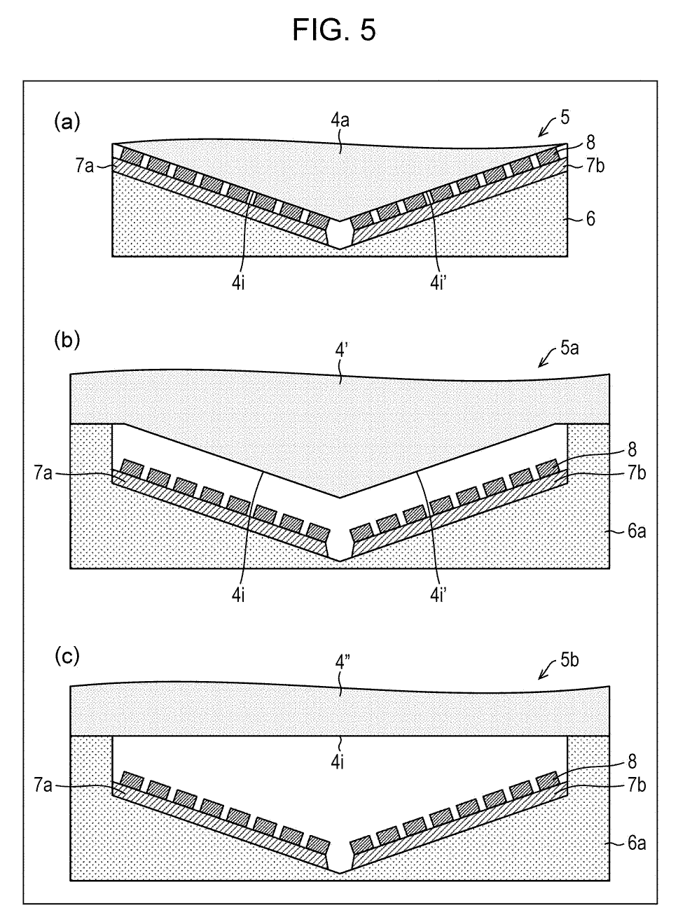

FIG. 5 is a diagram showing the light guide area 4a of the light guide plate 4 and the support unit 5 used in the illuminating device 1 shown in FIG. 1, and light guide areas 4′ and 4″ of other light guide plates and other support units 5a and 5b that can be used in the illuminating device shown in FIG. 1.

FIG. 5 (a) is a diagram showing the light guide area 4a of the light guide plate 4 and the support unit 5 used in the illuminating device 1 shown in FIG. 1, so that the description thereof will be omitted.

FIG. 5 (b) is a diagram showing the light guide area 4′ of another light guide plate and another support unit 5a that can be used in the illuminating device 1 shown in FIG. 1.

As shown in FIG. 5 (b), the light guide area 4′ of the light guide plate and a heat dissipation material 6a are provided with a mechanism (for example, a guide) for separating incident surfaces 4i and 4i′ of the light guide plate away from the light sources 8 by a predetermined distance.

FIG. 5 (c) is a diagram showing the light guide area 4″ of another light guide plate and another support unit 5b that can be used in the illuminating device 1 shown in FIG. 1.

As shown in FIG. 5 (c), the light guide area 4″ of the light guide plate and the heat dissipation material 6a are provided with a mechanism (for example, a guide) for separating the incident surface 4i of the light guide plate away from the light sources 8 by a predetermined distance or more.

As shown in FIG. 5 (b) and FIG. 5 (c), the configurations where the incident surfaces of the light guide plate are separated away from the light sources can be preferably applied to, for example, a case where there is a concern that the light guide plate is thermally expanded and the incident surface of the light guide plate hits the light sources to cause damage, and a case where there is a concern that the light sources hit the incident surface of the light guide plate due to external vibration or shock from a physical problem and thereby a physical stress is applied to the light sources and the light sources are damaged.

When there is a concern that the light guide plate is thermally expanded and the incident surface of the light guide plate hits the light sources to cause damage, it is preferable to determine how long the incident surface of the light guide plate is separated away from the light sources by considering the thermal expansion coefficient of the light guide plate according to temperature.

### Second Embodiment

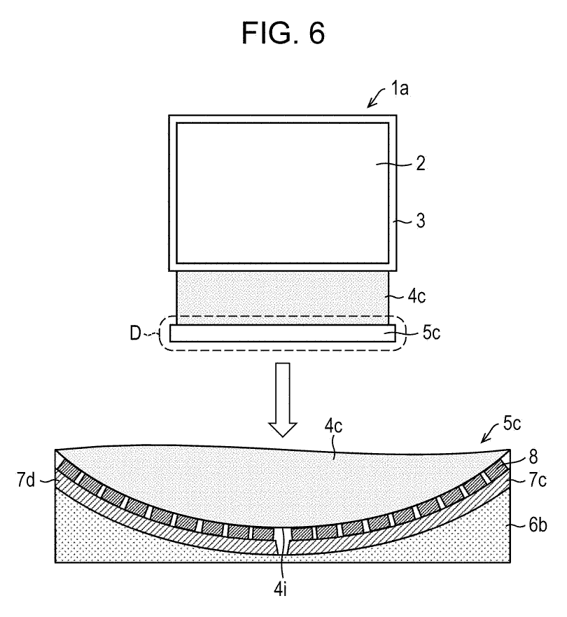

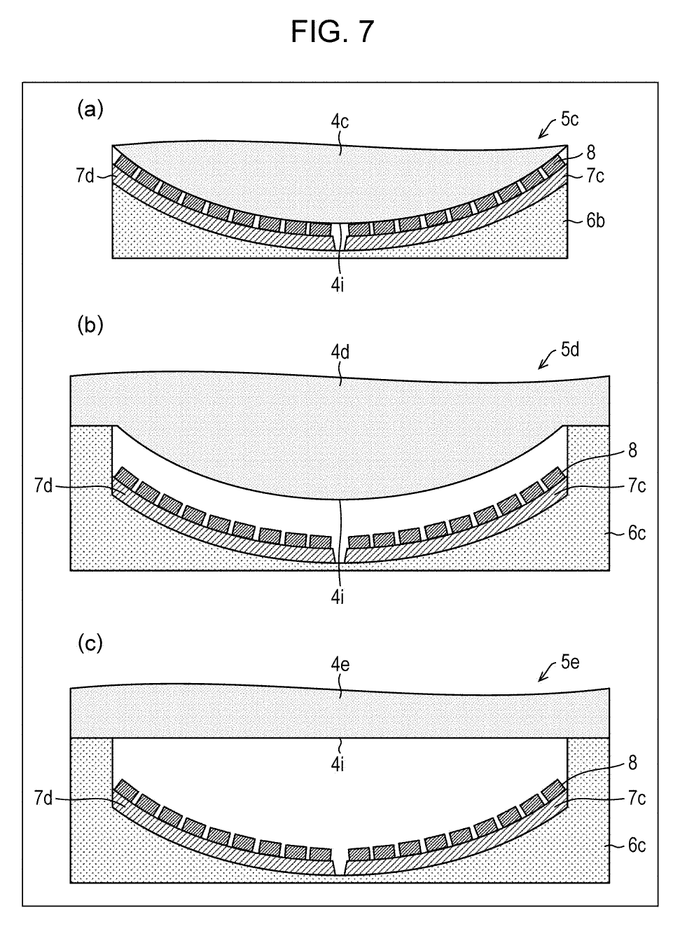

Next, a second embodiment of the disclosure will be described with reference to FIGS. 6 and 7. The present embodiment is different from the first embodiment in that a plurality of light sources 8 are arranged in a curved shape in a support unit 5c, and the others are the same as those described in the first embodiment. For convenience of description, members having the same function as those shown in the drawings of the first embodiment are denoted by the same reference numerals, and the description thereof will be omitted.

FIG. 6 is a diagram showing a schematic configuration of an illuminating device 1a.

As shown in FIG. 6, the illuminating device 1a includes a protective cover 2, a frame (bezel) 3 covering an edge portion of the protective cover 2, a light guide plate including an incident surface 4i and a light guide area 4c, and a support unit 5c.

In FIG. 6, as shown in an enlarged diagram of an area D indicated by a dotted line, the plurality of light sources 8 are arranged in a curved shape in the support unit 5c. The light guide plate includes the incident surface 4i having a curved shape through which light from light sources 8 enters the light guide plate, a light guide area 4c for sufficiently diffusing the light entering through the incident surface 4i and guiding the light to a light emitting area (not shown in the drawings), and the light emitting area (not shown in the drawings) from which the light from the light guide area 4c is emitted.

The light guide plate is supported by the support unit 5c that houses the plurality of light sources 8, the incident surface 4i, and at least a part of the light guide area 4c, so that the illuminating device 1a has a structure that can self-stand.

In the present embodiment, in order to arrange the plurality of light sources 8 in a curved shape in the support unit 5c, an upper surface of a heat dissipation material 6b is formed in a curved shape and two light source substrates 7c and 7d are also formed in a curved shape. However, the support unit 5c is not limited to the above if the plurality of light sources 8 can be arranged in a curved shape in the support unit 5c.

In the present embodiment, two divided light source substrates 7c and 7d are used. However, the light source substrates are not limited to the above, but one light source substrate formed in a curved shape may be used.

In the present embodiment, a case where a plurality of light sources 8 are arranged in a curved shape, specifically, in a concave shape, and the incident surface 4i of the light guide plate is formed in a downward convex shape and has an engageable structure in the support unit 5c is described as an example. However, the support unit 5c is not limited to the above, but the plurality of light sources 8 may be arranged in a curved shape, specifically, in a convex shape, and the incident surface 4i of the light guide plate may be formed in a concave shape and may have an engageable structure in the support unit 5c.

Because of the configuration as described above, in the case of the illuminating device 1a, a frame width of a lower frame (bezel) 3 need not be set wide, so that all of the upper, lower, left, and right sides of the frame (bezel) 3 can be narrowed. Therefore, it is possible to improve the design property of the illuminating device 1a.

Further, the light guide area 4c of the light guide plate is used as a member (stand) that connects the light emitting area of the light guide plate with the support unit 5c, so that the light guide area 4c of the light guide plate can be elongated, and luminance uniformity of light incident from the light sources 8 can be sufficiently improved.

In the case of the illuminating device 1a, the light sources 8 are housed in the support unit 5c, so that the arrangement of the light sources 8 does not affect the frame width. Therefore, in the illuminating device 1a, a plurality of light sources 8 are arranged in a curved shape, so that it is possible to increase the number of light sources 8 that can be arranged and increase the brightness of the illuminating device 1a without increasing the frame width.

In the case of the illuminating device 1a, the light guide area 4c of the light guide plate is used as a member (stand) that connects the light emitting area of the light guide plate with the support unit 5c, so that the light guide area 4c of the light guide plate can be elongated, and light is emitted from the light emitting surface of the light emitting area of the light guide plate after the incident light unevenness of the light from the light sources 8 is eliminated in the long light guide area 4c of the light guide plate. Thus, the luminance uniformity of the illuminating device 1a can be improved without increasing the frame width.

Further, in the case of the illuminating device 1a, the light sources 8 are housed in the support unit 5c, so that a heat dissipation material 6b, whose size is relatively large, may be provided in the support unit 5c. Therefore, it is possible to improve the durability (product life) of the illuminating device 1a without increasing the frame width.

Also in the case of the illuminating device 1a, the heat dissipation material 6b is arranged so as to be in contact with the chassis portion 9 and the housing 10, which are a ground contact surface, in the support unit 5c. Therefore, heat exhaust of the light sources 8 is realized by a heat dissipation mechanism including the heat dissipation material 6b in the support unit 5c, so that a cooling effect is obtained and it is possible to dissipate heat by diffusing heat to the ground contact surface through the heat dissipation material 6b. Thus, it is possible to suppress degradation of luminous efficiency of the light sources 8 due to heat generation. This cooling effect is greater than that of air convection of chimney effect.

FIG. 7 is a diagram showing the light guide area 4c of the light guide plate and the support unit 5c used in the illuminating device 1a shown in FIG. 6, and light guide areas 4d and 4e of other light guide plates and other support units 5d and 5e that can be used in the illuminating device 1a shown in FIG. 6.

FIG. 7 (a) is a diagram showing the light guide area 4c of the light guide plate and the support unit 5c used in the illuminating device 1a shown in FIG. 6, so that the description thereof will be omitted.

FIG. 7 (b) is a diagram showing the light guide area 4d of another light guide plate and another support unit 5d that can be used in the illuminating device 1a shown in FIG. 6.

As shown in FIG. 7 (b), the light guide area 4d of the light guide plate and a heat dissipation material 6c are provided with a mechanism (for example, a guide) for separating the incident surface 4i of the light guide plate away from the light sources 8 by a predetermined distance.

FIG. 7 (c) is a diagram showing the light guide area 4e of another light guide plate and another support unit 5e that can be used in the illuminating device 1a shown in FIG. 6.

As shown in FIG. 7 (c), the light guide area 4e of the light guide plate and the heat dissipation material 6c are provided with a mechanism (for example, a guide) for separating the incident surface 4i of the light guide plate 4 away from the light sources 8 by a predetermined distance or more.

As shown in FIG. 7 (b) and FIG. 7 (c), the configurations where the incident surface of the light guide plate is separated away from the light sources can be preferably applied to, for example, a case where there is a concern that the light guide plate is thermally expanded and the incident surface of the light guide plate hits the light sources to cause damage, and a case where there is a concern that the light sources hit the incident surface of the light guide plate due to external vibration or shock from a physical problem and thereby a physical stress is applied to the light sources and the light sources are damaged.

When there is a concern that the light guide plate is thermally expanded and the incident surface of the light guide plate hits the light sources to cause damage, it is preferable to determine how long the incident surface of the light guide plate is separated away from the light sources by considering the thermal expansion coefficient of the light guide plate according to temperature.

### Third Embodiment

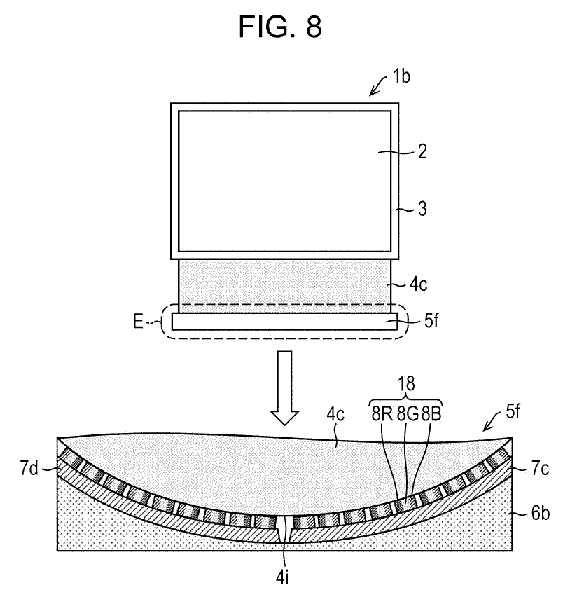

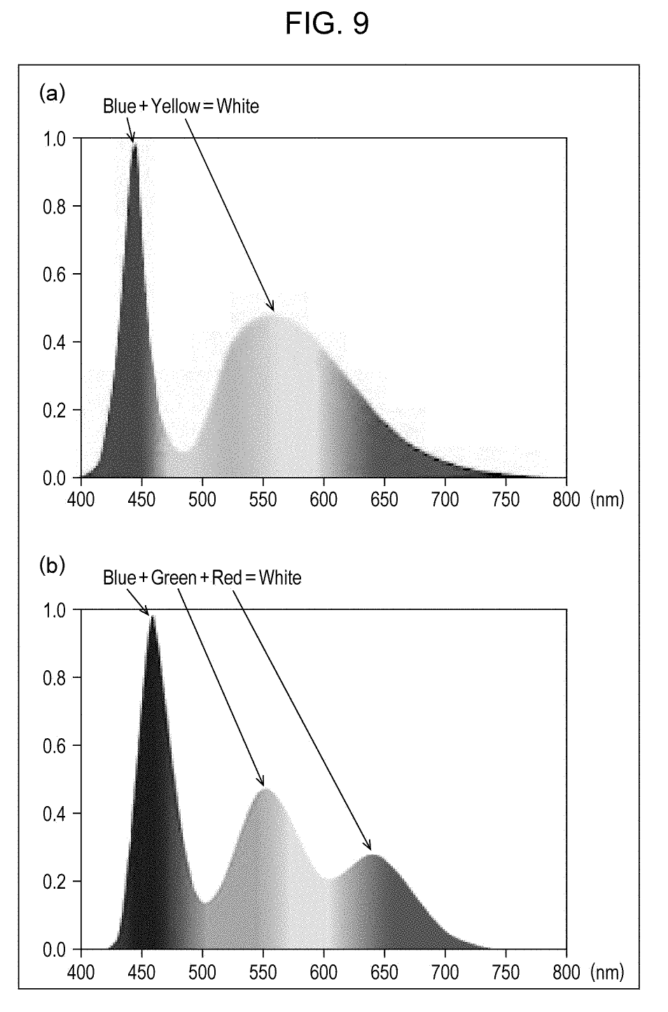

Next, a third embodiment of the disclosure will be described with reference to FIGS. 8 and 9. The present embodiment is different from the first and the second embodiments in that light source units are arranged as light sources 18 in a support unit 5f and in each light source unit, a red light emitting diode element 8R, a green light emitting diode element 8G, and a blue light emitting diode element 8B are arranged adjacent to each other, and the others are the same as those described in the first and the second embodiments. For convenience of description, members having the same function as those shown in the drawings of the first and the second embodiments are denoted by the same reference numerals, and the description thereof will be omitted.

FIG. 8 is a diagram showing a schematic configuration of an illuminating device 1b including light source units, in each of which the red light emitting diode element 8R, the green light emitting diode element 8G, and the blue light emitting diode element 8B are arranged adjacent to each other as the light source 18, in the support unit 5f.

FIG. 9 is a diagram showing a spectrum of light from the light sources 8 used in the illuminating device 1 shown in FIG. 1 and the illuminating device 1a shown in FIG. 6 and a spectrum of light from the light source units used as the light sources 18 used in the illuminating device 1b shown in FIG. 8.

As shown in FIG. 9 (a), the light source 8 used in the illuminating device 1 shown in FIG. 1 and the illuminating device 1a shown in FIG. 6 is a white light emitting diode element (white LED element) including a blue light emitting element and Yttrium Aluminum Garnet (YAG) added with Ce which is a phosphor that emits yellow light (blue-exciting YAG phosphor), so that a spectrum of the light of the white light emitting diode element has a peak value in a blue wavelength region and a yellow wavelength region and shows a pseudo white color.

On the other hand, as shown in FIG. 9 (b), the light source unit used as the light source 18 used in the illuminating device 1b shown in FIG. 8 has a configuration where the red light emitting diode element 8R, the green light emitting diode element 8G, and the blue light emitting diode element 8B are arranged adjacent to each other, so that a spectrum of light of the light source unit has a peak value in a blue wavelength region, a green wavelength region, and a red wavelength region, and the light source unit can emits light having higher color reproducibility.

### Fourth Embodiment

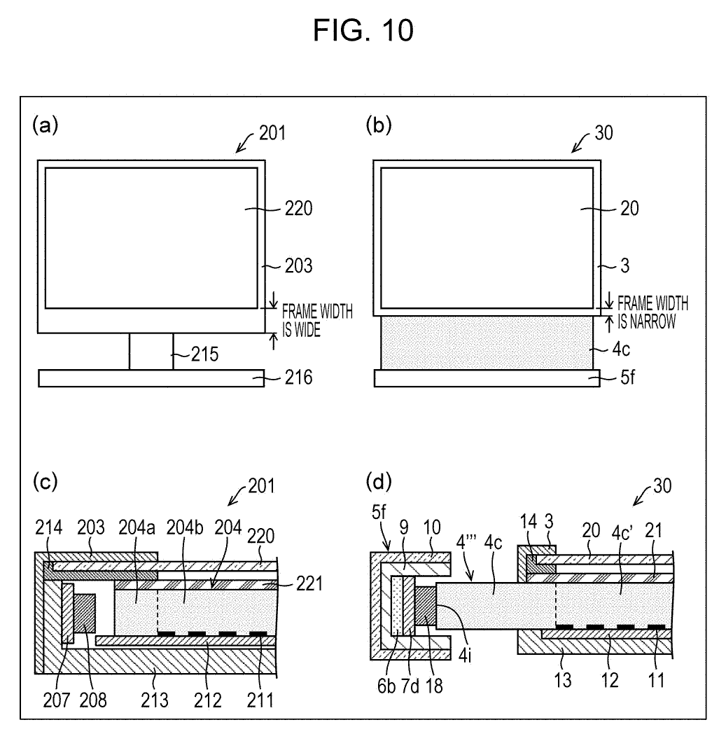

Next, a fourth embodiment of the disclosure will be described with reference to FIG. 10. The present embodiment is different from the first to the third embodiments in that a liquid crystal display device 30 includes a liquid crystal display panel 20 and an illuminating device 1b, from which the protective cover is removed, as a backlight, and the others are the same as those described in the first to the third embodiments. For convenience of description, members having the same function as those shown in the drawings of the first to the third embodiments are denoted by the same reference numerals, and the description thereof will be omitted.

FIG. 10 is a diagram showing a frame width of the liquid crystal display device 30 and a frame width of a conventional liquid crystal display device 201.

FIG. 10 (a) shows the frame width of the conventional liquid crystal display device 201. FIG. 10 (b) shows the frame width of the liquid crystal display device 30. FIG. 10 (c) shows a cross-sectional view of the conventional liquid crystal display device 201. FIG. 10 (d) shows a cross-sectional view of the liquid crystal display device 30.

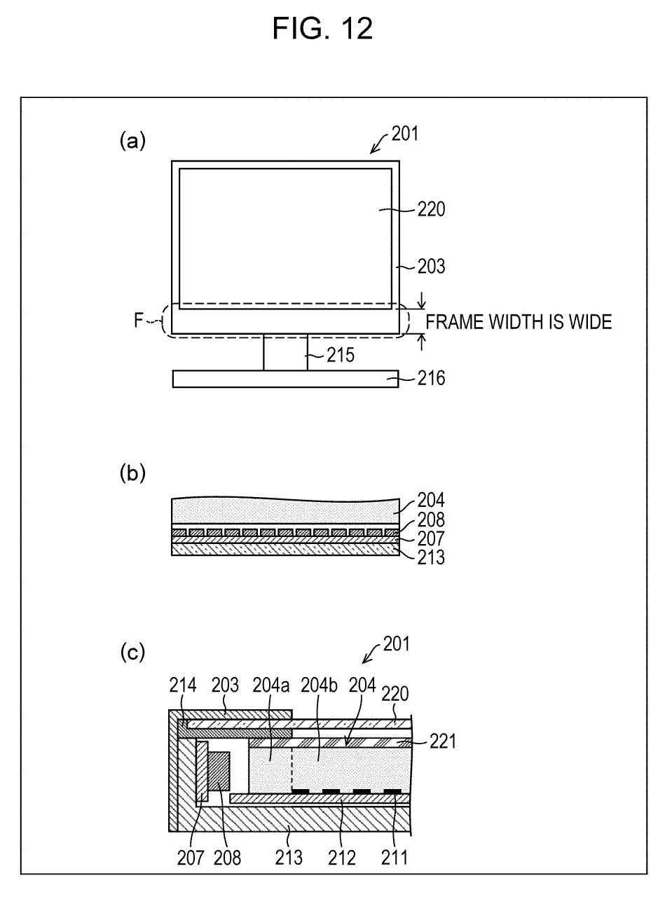

The conventional liquid crystal display device 201 shown in FIG. 10 (a) and FIG. 10 (c) has been described based on FIG. 12, so that the description thereof will be omitted here.

The liquid crystal display device 30 shown in FIG. 10 (b) and FIG. 10 (d) includes the liquid crystal display panel 20, the illuminating device 1b described above, from which the protective cover is removed, as a backlight, and an optical sheet 21 (luminance improving film) provided on a light emitting surface side of a light guide plate 4′″ facing the liquid crystal display panel 20.

Because of the configuration as described above, in the case of the liquid crystal display device 30, a frame width of a lower frame (bezel) 3 need not be set wide, so that all of the upper, lower, left, and right sides of the frame (bezel) 3 can be narrowed. Therefore, it is possible to improve the design property of the liquid crystal display device 30.

Further, the light guide area 4c of the light guide plate is used as a member (stand) that connects a light emitting area 4c′ of the light guide plate with the support unit 5f, so that the light guide area 4c of the light guide plate can be elongated, and luminance uniformity of light incident from the light sources 18 can be sufficiently improved.

In the case of the liquid crystal display device 30, the light sources 18 are housed in the support unit 5f, so that the arrangement of the light sources 18 does not affect the frame width. Therefore, in the liquid crystal display device 30, a plurality of light sources 18 are arranged in a curved shape, so that it is possible to increase the number of light sources 18 that can be arranged and increase the brightness of the liquid crystal display device 30 without increasing the frame width. The resolution of the liquid crystal display panel 20 included in the liquid crystal display device 30 tends to increase, and light transmittance per pixel tends to decrease, so that a technique that increases the number of light sources that can be arranged without increasing the frame width can be preferably used for a high resolution liquid crystal display panel.

In the case of the liquid crystal display device 30, the light guide area 4c of the light guide plate 4′″ is used as a member (stand) that connects the light emitting area 4c′ of the light guide plate 4′″ with the support unit 5f, so that the light guide area 4c of the light guide plate 4′″ can be elongated, and light is emitted from the light emitting surface of the light emitting area 4c′ of the light guide plate 4′″ after the incident light unevenness of the light from the light sources 18 is eliminated in the long light guide area 4c′ of the light guide plate 4′″. Thus, the luminance uniformity of the liquid crystal display device 30 can be improved without increasing the frame width.

Further, in the case of the liquid crystal display device 30, the light sources 18 are housed in the support unit 5f, so that the heat dissipation material 6b, whose size is relatively large, may be provided in the support unit 5f. Therefore, it is possible to improve the durability (product life) of the liquid crystal display device 30 without increasing the frame width.

Also in the case of the liquid crystal display device 30, the heat dissipation material 6b is arranged so as to be in contact with the chassis portion 9 and the housing 10, which are a ground contact surface, in the support unit 5f. Therefore, heat exhaust of the light sources 18 is realized by a heat dissipation mechanism including the heat dissipation material 6b in the support unit 5f, so that a cooling effect is obtained and it is possible to dissipate heat by diffusing heat to the ground contact surface through the heat dissipation material 6b. Thus, it is possible to suppress degradation of luminous efficiency of the light sources 18 due to heat generation. This cooling effect is greater than that of air convection of chimney effect.

### Fifth Embodiment

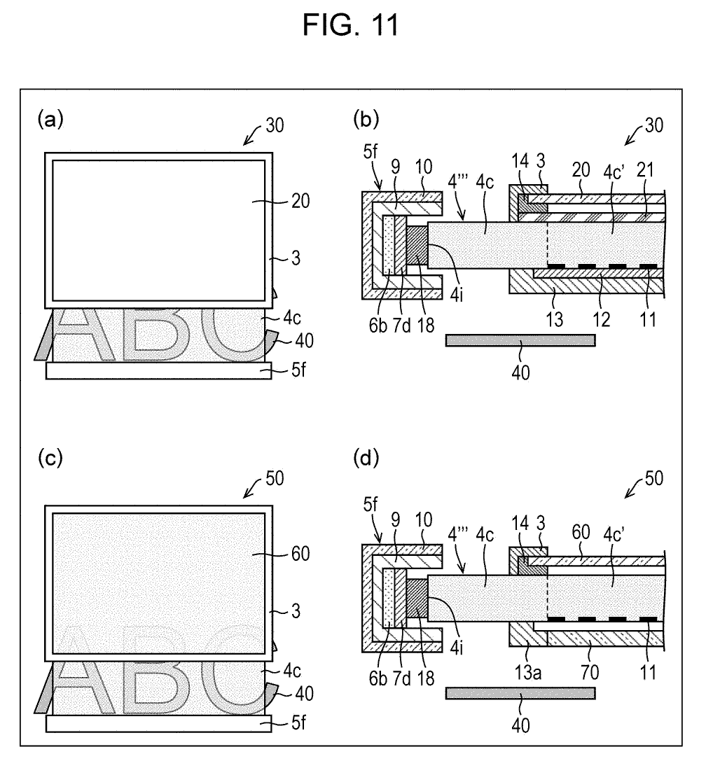

Next, a fifth embodiment of the disclosure will be described with reference to FIG. 11. The present embodiment is different from the fourth embodiment in that a liquid crystal display device 50 includes a transparent liquid crystal display panel 60, and the others are the same as those described in the fourth embodiment. For convenience of description, members having the same function as those shown in the drawings of the fourth embodiment are denoted by the same reference numerals, and the description thereof will be omitted.

FIG. 11 (a) and FIG. 11 (b) are diagrams for explaining a degree of transparency in the case of the liquid crystal display device 30 that uses a normally black type liquid crystal display panel as the liquid crystal display panel 20. FIG. 11 (c) and FIG. 11 (d) are diagrams for explaining a degree of transparency in the case of the liquid crystal display device 50 including the transparent liquid crystal display panel 60.

As shown in FIG. 11 (a) and FIG. 11 (b), the letters ABC written on paper 40 can be seen through in a portion where the letters ABC do not overlap with the housing 10 and the frame (bezel) 3 in plan view in the light guide area 4c of the light guide plate 4′″ regardless of ON/OFF of the light sources 18.

On the other hand, the liquid crystal display panel 20 is a normally black type liquid crystal display panel, and the reflection sheet 12 and the optical sheet 21 (luminance improving film) are arranged so as to overlap with the liquid crystal display panel 20 in plan view, so that the letters ABC written on the paper 40 cannot be seen through through the liquid crystal display panel 20 regardless of ON/OFF of the light sources 18.

As shown in FIG. 11 (c), in the case of the liquid crystal display device 50 including the transparent liquid crystal display panel 60, the letters ABC written on the paper 40 can be seen through in a portion where the letters ABC do not overlap with the housing 10 and the frame (bezel) 3 in plan view in the light guide area 4c of the light guide plate 4′″ regardless of ON/OFF of the light sources 18, and the letters ABC can be seen through or cannot be seen through through the transparent liquid crystal display panel 60 depending on the brightness of the light sources 18. Specifically, when the light sources 18 strongly emit light, the light transmits through the letters ABC, so that the letters ABC cannot be seen, but when the light sources 18 weakly emit light, the letters ABC can be seen through.

As shown in FIG. 11 (d), in the liquid crystal display device 50, the transparent liquid crystal display panel 60 is used instead of the normally black type liquid crystal display panel, an opaque backlight chassis 13a and a transparent protective plate 70 are used instead of the opaque backlight chassis 13, and the reflection sheet 12 and the optical sheet 21 (luminance improving film) are not included.

As described above, in the case of the liquid crystal display device 50, a background can be seen from a front surface side and a back surface side of the liquid crystal display device 50 through the transparent liquid crystal display panel 60 and a portion where the background does not overlap with the housing 10 and the frame (bezel) 3 in plan view in the light guide area 4c of the light guide plate 4′″, so that it is possible to realize a display device whose interior property is enhanced.

### SUMMARY

An illuminating device according to an aspect 1 of the disclosure includes a plurality of light sources and a light guide plate. The illuminating device can be self-stood by a support unit. The light guide plate includes an incident surface through which light from the light sources enters the light guide plate, a light guide area for guiding the light entering from the incident surface to a light emitting area, and the light emitting area from which the light from the light guide area is emitted. The support unit houses the light sources, the incident surface, and at least a part of the light guide area. The light guide plate is supported by the support unit.

According to the configuration described above, the light sources, the incident surface, and at least a part of the light guide area are housed in the support unit, and the light guide plate is supported by the support unit.

Therefore, in the illuminating device described above, the light guide area of the light guide plate is used as a member that connects the light emitting area of the light guide plate with the support unit, and at least a part of the light guide area of the light guide plate is housed in the support unit, so that the length of the light guide area of the light guide plate can be set relatively long and luminance uniformity of the illuminating device can be secured without increasing a frame width.

Further, the light sources and the incident surface of the light guide plate are housed in the support unit, so that an arrangement form of the light sources can be changed relatively freely. Therefore, the number of the light sources that can be arranged can be increased and the brightness of the illuminating device can be secured without increasing the frame width.

Further, a heat dissipation material can be mounted near the light sources in the support unit, so that it is possible to secure the durability (product life) of the illuminating device without increasing the frame width.

As described above, the illuminating device can secure the brightness, the luminance uniformity, and the durability (product life) without increasing the frame width, and can self-stand because the light guide plate is supported by the support unit.

In the aspect 1 described above, in an illuminating device according to an aspect 2 of the disclosure, a part of the plurality of light sources arranged linearly may be arranged in non-parallel with the other part of the plurality of light sources arranged linearly.

According to the configuration described above, the number of light sources that can be arranged can be increased, so that brightness can be secured without increasing the frame width.

In the aspect 1 described above, in an illuminating device according to an aspect 3 of the disclosure, the plurality of light sources may be arranged in a curved shape.

According to the configuration described above, the number of light sources that can be arranged can be increased, so that brightness can be secured without increasing the frame width.

In the aspect 2 described above, in an illuminating device according to an aspect 4 of the disclosure, the incident surface includes a first incident surface and a second incident surface, the first incident surface and the second incident surface are formed in non-parallel to each other, a part of the plurality of light sources arranged linearly may be arranged along the first incident surface, and the other part of the plurality of light sources arranged linearly may be arranged along the second incident surface.

According to the configuration described above, the light sources are arranged along the incident surfaces of the light guide plate, so that an incidence efficiency from the light sources to the light guide plate can be enhanced.

In the aspect 3 described above, in an illuminating device according to an aspect 5 of the disclosure, the incident surface is formed into a curved surface and the plurality of light sources arranged in the curved shape may be arranged along the curved surface.

According to the configuration described above, the light sources are arranged along the incident surface of the light guide plate, so that the incidence efficiency from the light sources to the light guide plate can be enhanced.

In any one of the aspects 1 to 5 described above, in an illuminating device according to an aspect 6 of the disclosure, it is preferable that a heat dissipation material is provided in the support unit.

According to the configuration described above, the heat dissipation material is mounted in the support unit, so that it is possible to secure the durability (product life) of the illuminating device without increasing the frame width.

In the aspect 6 described above, in an illuminating device according to an aspect 7 of the disclosure, it is preferable that the heat dissipation material is in contact with a ground contact surface of the support unit.

According to the configuration described above, it is possible to dissipate heat by diffusing heat to the ground contact surface through the heat dissipation material.

In the aspect 6 or 7 described above, in an illuminating device according to an aspect 8 of the disclosure, the heat dissipation material may be any one selected from an aluminum material, a copper material, a steel material, and a ceramic material.

According to the configuration described above, the heat dissipation material is any one selected from an aluminum material, a copper material, a steel material, and a ceramic material, so that the heat dissipation material is suitable in terms of heat dissipation, processing easiness, and making the illuminating device self-standable.

In any one of the aspects 1 to 8 described above, in an illuminating device according to an aspect 9 of the disclosure, the plurality of light sources are a plurality of light source units, and it is preferable that in each light source unit, a red light emitting diode element, a green light emitting diode element, and a blue light emitting diode element are arranged adjacent to each other.

According to the configuration described above, an illuminating device having high color reproducibility can be realized.

In any one of the aspects 1 to 8 described above, in an illuminating device according to an aspect 10 of the disclosure, the plurality of light sources may be white light emitting diode elements, each of which includes a blue light emitting element and a blue-exciting Yttrium Aluminum Garnet phosphor.

According to the configuration described above, the plurality of light sources are the white light emitting diode elements, so that more light sources can be arranged as compared with a case where light source units, each of which includes three color light-emitting diodes.

A display device according to an aspect 11 of the disclosure may include the illuminating device according to any one of the aspects 1 to 10 and a liquid crystal display panel.

According to the configuration described above, it is possible to realize a display device that can secure the brightness, the luminance uniformity, and the durability (product life) without increasing the frame width, and can self-stand.

In the aspect 11 described above, in a display device according to an aspect 12 of the disclosure, the liquid crystal display panel may be a transparent liquid crystal display panel.

According to the configuration described above, it is possible to realize a display device whose interior property is enhanced.

[Supplementary Note]

The disclosure is not limited to the embodiments described above, but can be variously modified within the scope of the claims. An embodiment obtained by appropriately combining technical means disclosed in different embodiments is also included in the technical scope of the disclosure. Further, it is possible to form novel technical features by combining the technical means disclosed respectively in the embodiments.

### INDUSTRIAL APPLICABILITY

The disclosure can be used for an illuminating device and a display device.

### REFERENCE SIGNS LIST

1 ILLUMINATING DEVICE
1a ILLUMINATING DEVICE
1b ILLUMINATING DEVICE
2 PROTECTIVE COVER
3 FRAME (BEZEL)
4 LIGHT GUIDE PLATE
4′ LIGHT GUIDE AREA
4″ LIGHT GUIDE AREA
4′″ LIGHT GUIDE PLATE
4a LIGHT GUIDE AREA
4b LIGHT EMITTING AREA
4c LIGHT GUIDE AREA
4c LIGHT EMITTING AREA
4d LIGHT GUIDE AREA
4e LIGHT GUIDE AREA
4i INCIDENT SURFACE
4i′ INCIDENT SURFACE
5 SUPPORT UNIT
5a to 5f SUPPORT UNIT
6 HEAT DISSIPATION MATERIAL
6a HEAT DISSIPATION MATERIAL
6b HEAT DISSIPATION MATERIAL
6c HEAT DISSIPATION MATERIAL
7a to 7d LIGHT SOURCE SUBSTRATE
8 LIGHT SOURCE
8R RED LIGHT EMITTING DIODE ELEMENT
8G GREEN LIGHT EMITTING DIODE ELEMENT
8B BLUE LIGHT EMITTING DIODE ELEMENT
9 CHASSIS PORTION
10 HOUSING
11 DOT
12 REFLECTION SHEET
13 BACKLIGHT CHASSIS
13a BACKLIGHT CHASSIS
14 PLASTIC CHASSIS
18 LIGHT SOURCE
20 LIQUID CRYSTAL DISPLAY PANEL
21 OPTICAL SHEET
30 LIQUID CRYSTAL DISPLAY DEVICE (DISPLAY DEVICE)
50 LIQUID CRYSTAL DISPLAY DEVICE (DISPLAY DEVICE)
60 TRANSPARENT LIQUID CRYSTAL DISPLAY PANEL
70 TRANSPARENT PROTECTIVE PLATE

1. An illuminating device that can be self-stood by a support unit, the illuminating device comprising: a plurality of light sources; and a light guide plate, wherein
the light guide plate includes an incident surface through which light from the light sources enters the light guide plate, a light guide area for guiding the light entering from the incident surface to a light emitting area, and the light emitting area from which the light from the light guide area is emitted, and
the support unit houses the light sources, the incident surface, and at least a part of the light guide area, and the light guide plate is supported by the support unit.

2. The illuminating device according to claim 1, wherein a part of the plurality of light sources arranged linearly may be arranged in non-parallel with the other part of the plurality of light sources arranged linearly.

3. The illuminating device according to claim 1, wherein the plurality of light sources is arranged in a curved shape.

4. The illuminating device according to claim 2, wherein
the incident surface includes a first incident surface and a second incident surface,
the first incident surface and the second incident surface are formed in non-parallel to each other,
a part of the plurality of light sources arranged linearly may be arranged along the first incident surface, and
the other part of the plurality of light sources arranged linearly may be arranged along the second incident surface.

5. The illuminating device according to claim 3, wherein
the incident surface is formed into a curved surface, and
the plurality of light sources arranged in the curved shape are arranged along the curved surface.

6. The illuminating device according to claim 1, wherein a heat dissipation material is provided in the support unit.

7. The illuminating device according to claim 6, wherein the heat dissipation material is in contact with a ground contact surface of the support unit.

8. The illuminating device according to claim 6, wherein the heat dissipation material is any one selected from an aluminum material, a copper material, a steel material, and a ceramic material.

9. The illuminating device according to claim 1, wherein
the plurality of light sources are a plurality of light source units, and
in each light source unit, a red light emitting diode element, a green light emitting diode element, and a blue light emitting diode element are arranged adjacent to each other.

10. The illuminating device according to claim 1, wherein the plurality of light sources are white light emitting diode elements, each of which includes a blue light emitting element and a blue-exciting Yttrium Aluminum Garnet phosphor.

11. A display device comprising: the illuminating device according to claim 1; and, a liquid crystal display panel.

12. The display device according to claim 11, wherein the liquid crystal display panel is a transparent liquid crystal display panel.
